(19) United States
(12) Patent Application Publication
(10) Pub. No.: US 2009/0007978 A1
(43) Pub. Date: Jan. 8, 2009

(54) HVAC air distribution valve

(75) Inventors: Gerald Allen Alston, Union City, CA (US); Machiko Taylor, Alameda, CA (US); Justin Richard Dobbs, San Ramon, CA (US)

Correspondence Address: FOLEY AND LARDNER LLP;SUITE 500, 3000 K STREET NW, WASHINGTON, DC, 20007, US

(73) Assignee: GLACIER BAY, INC.

(21) Appl. No.: 11/822,283

(22) Filed: Jul. 3, 2007

(51) Int. Cl. F16K 3/00

(52) U.S. Cl. 137/872

(57) ABSTRACT

An HVAC diverter valve including a diverter valve body. The diverter valve body includes an inlet, a first outlet, and a second outlet. The HVAC diverter valve further includes a flow constrictor assembly, and at least one motor adapted to adjust the flow constrictor assembly to divert air entering the inlet to the first and second outlet and maintain a substantially constant backpressure in front of the valve during air diversion.

### BACKGROUND

Current HVAC systems come in a wide variety of configurations. These configurations vary greatly in cost, efficiency and their ability to provide consistently accurate temperature, humidity and ventilation control, simultaneously, to multiple vent locations. The ability to accurately control these parameters is desirable as it increases the comfort of the occupants and may, under certain conditions, increase the potential for energy savings.

Current systems that supply conditioned air to multiple vent locations suffer from a number of problems. For example, control of airflow through the system is accomplished by restricting the flow of air, which increases the backpressure of the air distribution system. This increase in pressure reduces the flow rate of the fan and the overall efficiency of the HVAC system. Moreover, current systems lack the ability to sufficiently change flow parameters into rooms when switching between a heating and cooling mode in a system that provides both heating and cooling, such as in a reverse-cycle heat pump. This lack of flexibility dictates that the during the original installation, the choice must be made whether to install the discharge vents high in a room (thereby maximizing comfort during cooling mode) or to install them low in the room (thus maximizing comfort when in heating mode).

### SUMMARY

Embodiments of the present invention offer an improved system for regulating the distribution of conditioned air in a forced-air HVAC system. By utilizing a network of diverter valves (which in some embodiments are smart/intelligent diverter valves) which, when under the control of a control unit that has received pre-set operational parameters and is receiving real-time data from a variety of sensors, regulates the flow of conditioned air to a plurality of outlet vents. These vents may be located within one or multiple enclosed or semi-enclosed spaces.

In an exemplary embodiment of the present invention, there is an HVAC system, comprising a first diverter valve adapted to divert air entering the valve and maintain a substantially constant backpressure in front of the valve during air diversion, a first sensor assembly adapted to sense a first environmental condition that includes at least one of temperature and a phenomenon indicative of the makeup of air, a control unit, and a user interface unit, wherein the control unit is in communication with the first diverter valve and the first sensor assembly.

In another embodiment of the present invention, there is an HVAC system as described above or below, wherein the first diverter valve is a Y valve including an inlet and two outlets adapted to route air entering the inlet into the outlets at varying routing ratios. In another embodiment of the present invention, there is an HVAC system as described above or below, wherein the first diverter valve is adapted to receive a communication initiated by the control unit and substantially steplessly vary a routing ratio of air routed into the two outlets based on that communication.

In another embodiment of the present invention, there is an HVAC system as described above or below, wherein the first diverter valve includes a stepper motor adapted to move a flap to accordingly vary the routing ratio of air routed into the two outlets. In another embodiment of the present invention, there is an HVAC system as described above or below, wherein the first diverter valve is adapted to output a signal indicative of at least one of the identity of the first diverter valve, a current routing ratio of the first diverter valve, and a relative position of a flap that diverts air in the first diverter valve. In another embodiment of the present invention, there is an HVAC system as described above or below, wherein the first diverter valve is electrically operated and stepless.

In another embodiment of the present invention, there is a method of delivering conditioned air in an HVAC system, comprising cooling or heating air, automatically directing the cooled or heated air into a first diverter valve, automatically routing, at a first routing ratio, the directed cooled or heated air to a first outlet near a ceiling in a first room a second outlet near a floor in the first room, automatically sensing an environmental condition that includes at least one of temperature and a phenomenon indicative of the makeup of air within the first room, and automatically routing, at a second routing ratio, the directed cooled or heated air to the first outlet and the second outlet, wherein a backpressure upstream of the location where the directed cooled or heated air is rerouted is substantially the same while routing at the second routing ratio and the first routing ratio.

In another embodiment of the present invention, there is a method of delivering conditioned air in an HVAC system as described above or below, wherein the second routing ratio is substantially different from the first routing ratio. In another embodiment of the present invention, there is a method of delivering conditioned air in an HVAC system as described above or below, further comprising sensing the environmental condition within the first room at two substantially different sensed altitudes within the room, wherein the environmental condition is air temperature, analyzing the sensed environmental condition and determining that a temperature gradient exists between the two substantially different sensed altitudes within the room, identifying a value of a control routing ratio to be used as the second routing ratio that will, within a desired period of time, substantially eliminate the temperature gradient between the two substantially different sensed altitudes; and using the control routing ratio as the second routing ratio.

### BRIEF DESCRIPTION OF THE DRAWINGS

FIG. 1 presents a conceptual diagram of an embodiment of an HVAC system according to the present invention.

FIG. 2 presents a conceptual diagram of a diverter valve connected to inlet and outlet ducts according to an embodiment of the present invention, where FIG. 2 depicts an exploded view of section A of FIG. 1.

FIG. 3 presents an isometric view of a diverter valve utilized in an embodiment of the present invention.

FIG. 4 presents a cutaway view of the diverter valve of FIG. 3.

FIG. 5 presents yet another conceptual diagram of another embodiment of an HVAC system according to the present invention.

FIG. 6 presents a conceptual diagram of another diverter valve connected to inlet and outlet ducts according to another embodiment of the present invention.

FIG. 7 presents a schematic diagram of a butterfly valve according to an embodiment of the present invention.

### DETAILED DESCRIPTION

In a first exemplary embodiment of the present invention, there is a forced-air HVAC system 100 comprising a heater/cooler unit 200 configured to variously heat and cool air (i.e., to output/produce conditioned air). The unit 200 includes a fan or blower (not shown) that generates an airflow out of the unit 200 to move the heated/cooled air through the HVAC system. In some embodiments, the unit 200 may be an integral unit, such as a heat pump, in which one cycle is a cooling cycle and another cycle (a reversed cycle) is a heating cycle. In yet other embodiments, the unit 200 includes a heating element and a separate cooling element such as may be found in a central air system. The HVAC system 100 includes an outlet duct 310 that extends between the heater/cooler unit 200 and a first diverter valve 410.

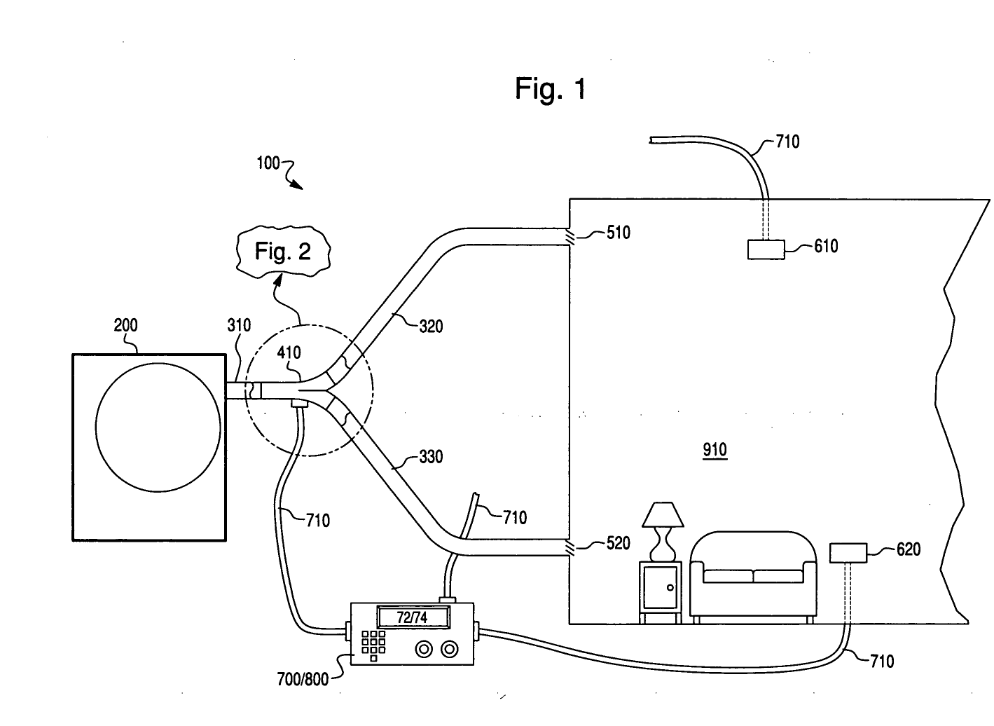

The diverter valve 410 in the embodiment shown in FIG. 1 is a Y valve, where the valve 410 splits the airflow traveling through duct 310 from heater/cooler unit 200 into two separate airflows traveling into ducts 320 and 330. Ducts 320 and 330 respectively lead to vents/outlets 510 and 520 in a room 910.

The diverter valve 410 is configured to divert airflow traveling through duct 310 into duct 320 and/or duct 330 in a manner that does not produce a significant change in backpressure when the flow of air is increased or decreased through one of the particular outlets of the diverter valve 410. That is, diverter valve 410 does not control flow by restricting the flow, but instead diverts the flow. Accordingly, the airflow through the system remains substantially constant during diversion unless changed at the air supply source (i.e., the heater/cooler unit 200). The flow in one duct leading to an outlet changes relative to the flow in the other ducts leading to an outlet, and an increase in airflow in one duct will substantially equally reduce the flow in other ducts.

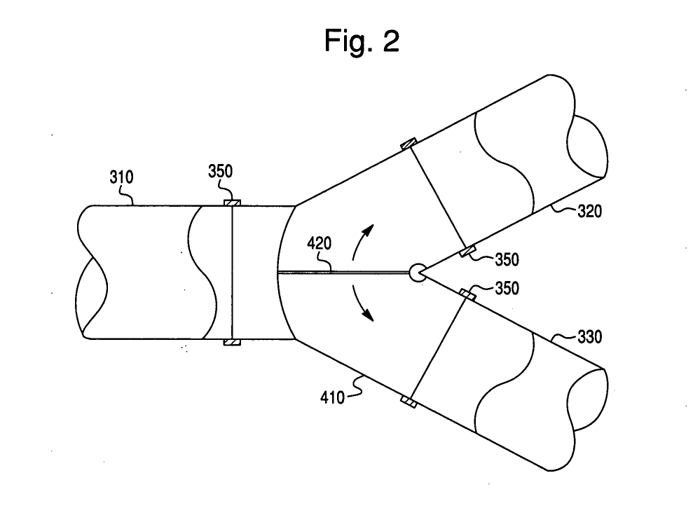

In some embodiments of the present invention, the diverter valve 410 is a stepper valve and the flap 420 (referring now to FIG. 2, which is an exploded view of section A of FIG. 1) may be placed in various locations in between its upper and lower (referring to FIG. 2) stops. When at the upper and lower stops, air is diverted such that 100 percent of the airflow traveling through duct 310 is diverted into duct 320 or 100 percent of the airflow traveling through duct 310 is diverted through duct 330. By placing the flap 420 at various locations in between the two stops, the percentages of air flowing down ducts 320 and 330 may be varied. For example, the flap 420 may be positioned such that 30 percent of the airflow traveling down duct 310 is diverted into duct 320 and the remaining 70 percent of the airflow traveling down duct 310 is diverted down duct 330, to achieve a routing ratio of 30/70 weighted to the duct 330. Flap 420 may be positioned such that any desired percentage of the total air flowing through duct 310 may be diverted down the ducts 310 and 320. That is, in some embodiments, the diverter valve 410 is configured such that the flap 420 may be positioned at any location between the upper and lower stops so as to divert any desired percentage of the airflow in duct 310 down one of the other ducts, the remainder of the airflow traveling through the other duct. When utilizing a valve in which the position of the flap 420 is stepless, any ratio of division of airflow can be achieved between the two outlet ducts.

In the embodiment depicted in FIGS. 1-4, the diverter valves (three-way) are constructed of a molded plastic in a shape which permits ready connection of one inlet duct and two outlet ducts by seals 350. As may be seen in FIG. 2, the ducts 310, 320 and 330 are connected to the diverter valve 410 in a substantially air type manner utilizing seals 350. More details regarding the diverter valves will be provided below, after the introduction of some of the other components of the HVAC system 100.

Room 910 includes a sensor assembly with a sensor 610 and a sensor 620, one of which is located nearer to the ceiling of the room 910, the other which is located nearer to the floor of the room 910, although in some embodiments, the placement of the sensors may be anywhere as long as the sensors are configured to sense an environmental condition at effectively substantially different altitudes within the room, such as an altitude near the ceiling and an altitude near the floor. In FIG. 1, the purpose of sensor 610 is to monitor an environmental condition (e.g. temperature, air quality etc., more on this below) near the ceiling, or at other altitudes substantially higher than an environmental condition sensed by sensor 620, which in the embodiment depicted in FIG. 910 is near the floor of room 910, and thus monitors the environmental conditions near the floor. In some embodiments, the actual physical placement of the sensors may be in a variety of locations, providing that the sensors mays sense the desired environmental conditions at the desire altitudes within the room. By way of example and not by way of limitation, a sensory assembly which utilizes infrared scanning may be positioned within the room 910 at about four feet above the floor (where the ceiling is eight feet above the floor), and this sensor assembly may utilize infrared sensing to sense air temperatures one or two feet below the ceiling and air temperatures one or two feet above the floor (indeed, such sensors may sense air temperatures at many number of altitudes, and thus the present invention is not limited to sensing conditions at only two altitudes). Still, in other embodiments, two or more separate sensors are utilized in the first sensor assembly, as is depicted in FIG. 1, one of the sensors being positioned about one or two feet above the floor and the other sensor being positioned at about one or two feet below the ceiling. The altitudes within the room where temperature is sensed maybe separated by anywhere between 3 and 8 feet. Of course, in a room with higher ceilings, the latter distance may be expanded as appropriate, and in other embodiments, the sensed altitudes may be even closer than 3 feet apart. Any sensor positioning within a room/any sensed altitudes within the room that will permit the present invention to be practiced may be utilized with embodiments of the present invention.

The sensor assembly is configured to collect information on one or more environmental conditions within room 910 and transmit that data to a control unit 700 via communication electronics which may be integrated into the sensor assembly or located remotely in other parts of the system (such as the control unit 700 and/or a user interface 800, etc.) The type of sensors utilized may vary according to the environmental conditions which are desired to be regulated. Some embodiments include sensors that may detect temperature, humidity, CO₂, CO and VOC levels, and thus embodiments of the present invention may be used to control the distribution of such conditions. In some embodiments of the invention, sensors for other specific gases or air-borne contaminates may be utilized.

As may be seen in FIG. 1, ducts 510 and 520 are respectively nearer to the ceiling and nearer to the floor of room 910. Thus, conditioned air exiting duct 510 will have a more immediate effect on the environmental condition at an altitude nearer the ceiling of room 510, and conditioned air exiting outlet 520 will have a more immediate effect on an environmental condition at an altitude nearer the floor of room 910, all things being equal (no ceiling fans, no venting that directs the airflows radically upward and downward, etc.). In the first embodiment of the present invention, duct 510 is about two feet below the ceiling in a room with an eight foot high ceiling, and duct 520 is about one foot above the floor in a room that has an eight foot high ceiling. In other embodiments, the duct 510 may be located in the ceiling and the duct 520 may be located in the floor, etc. In some embodiments of the present invention, outlet 520 is 2 feet above the floor and outlet 510 is 7 feet above the floor. In yet other embodiments of the invention, the outlets are separated anywhere between 3 and 8 feet, or various distances in between, in a room with an 8 foot high ceiling. Of course, in a room with higher ceilings, the latter distance may be expanded as appropriate, and in other embodiments, the outlets may be even closer than 3 feet apart. Any duct positioning within a room that will permit the present invention to be practiced may be utilized with embodiments of the present invention.

The HVAC system according to the first embodiment of the present invention includes a communication/control network, which may include wireless communication paths and/or wire communication paths, over which real time communication of current statuses of the various components of the system takes place. The network includes a control unit 700 and a user interface 800. While the control unit 700 and the user interface 800 are depicted in FIG. 1 as a single unitary assembly, some embodiments of the present invention may be practiced with those components being separate assemblies. The control unit may be a simple processor or a complex processor and/or be a series of linked processors. The processors include logic to execute control of the HVAC system. The control unit 700 is in communication with the diverter valve 410 and the sensor assembly which includes sensors 610 and 620 via communication lines 710. In the first embodiment of the present invention, communication lines 710 are electrical cables which permit signals from sensors 610 and 620 to be transmitted to the control unit 700 and permit signals to the diverter valve 410 to be transmitted from the control unit 700. In the case of transmission of signals to the diverter valve 410 from the control unit 700, those signals are such that the control unit 700 may control the position of the flap 420 within valve 410. In some embodiments of the present invention, the system is configured such that the diverter valves 410 will transmit signals to the control unit 700 and/or the control unit 700 will transmit signals to the sensor assembly.

The user interface 800 permits a user to input control commands into the HVAC system. By way of example and not by way of limitation, the user interface may permit a user to set a temperature within the room 910 so that the temperature will be 72 degrees Fahrenheit, or so that the temperature may be no lower than 72 degrees and no higher than 74 degrees Fahrenheit, etc. In some embodiments of the present invention, the user interface 800 permits a user to control environmental conditions relating to the temperature of air at various altitudes (which are substantially different from one another) within the room 910. For example, a desired temperature gradient within the room 910 between two or more altitudes may be effectively maintained.

The number of user interfaces that may be utilized may vary, and may be determined based on user convenience. In some embodiments, the user interface 800 allows the user to program in specific operational preferences and communicates functional data back to the user.

Communications between the various components may be achieved by any of a variety of network communication systems. For example, cable 710 may be utilized as detailed above. In other embodiments, wireless transmissions may be utilized. In a cable connected system, the type of cable used may be one suited to the network data type and the operating environment. In some embodiments, the cable provides for the reliable transmission of data as well as the low power required by the diverter valve stepper motor (discussed below) and communication electronics. In a wireless system, data may be transmitted wirelessly and power to the individual devices is provided by storage battery or wireless transmission using RF, infra red, evanescent wave coupling or similar technology. Any system/network/device/method that will permit the various components of the HVAC system to communicate with one another (and/or one or more intermediate components) may be utilized to practice embodiments of the present invention.

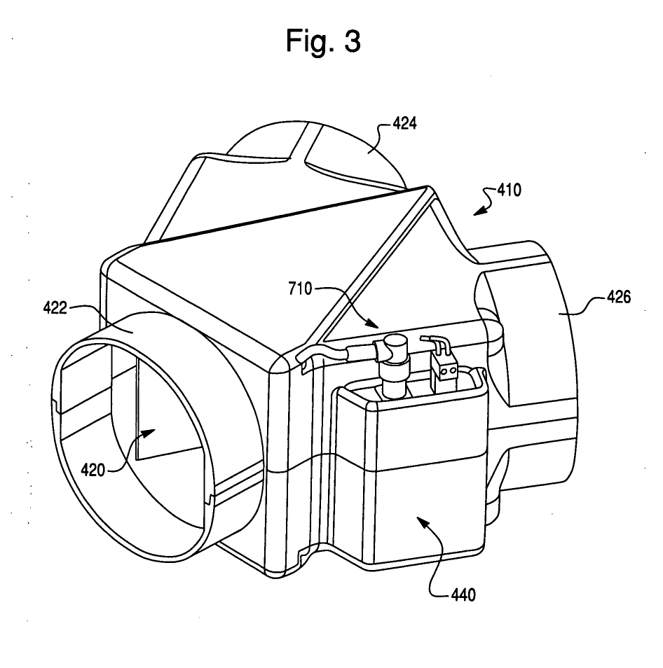

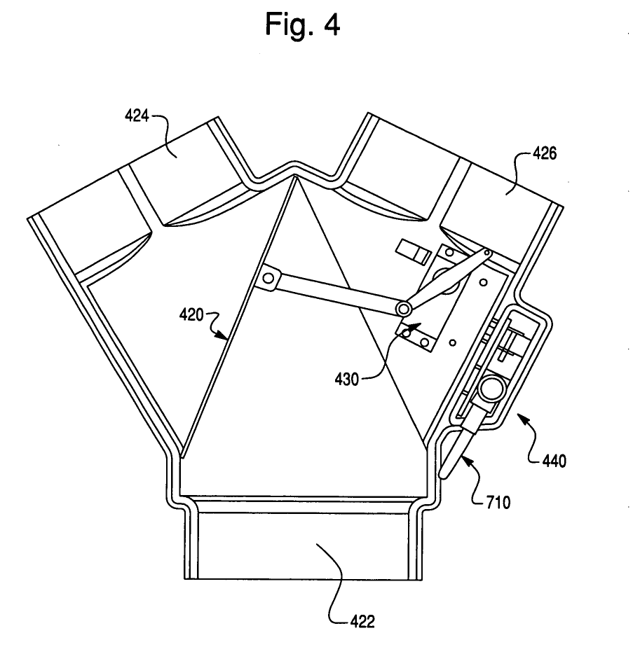

In the first embodiment of the present invention, referring now to FIGS. 3 and 4, the diverter valve 410 is a three way Y valve that includes an electrical stepper motor 430 under the control of the control unit 700. The stepper motor 430 is mechanically linked to the flap 420 and moves the flap in a stepless fashion to a range of locations between one side of the valve to the other side of the valve, thus routing air entering inlet 422 out the two outlets 424 and 426 at varying routing ratios (i.e., the percentage of the total amount of inlet air traveling through outlet 424 vs. the percentage of inlet air traveling through outlet 426.) The valves 410 are configured to route the air entering the inlet 422 out the outlet 424 and 426 in different varying amounts depending on the command received from the control unit 700.

The valve 410 may include an electronics package 440 connected to cables 710 through which the electronics package 440 receives commands from the control unit 700 and controls the stepper motor 430 to position the valve to position the flap 420 as needed to achieve the desired air routing ratio. In some embodiments of the present invention, the valves 410 are configured such that the position of the flap 420 is determined by the control unit 700 and thus the electronic package is essentially a slave unit slaved to the control unit 700. In some embodiments, the electronics package 440 is not needed when the diverter valve is slaved to the controller, the motor of the valve being directly controlled by the control unit. In other embodiments of the present invention, electronic package 440 of the valve 410 receives a signal from the control unit 700 indicative of a desired routing ratio through the outlets and/or indicative of a desired end environmental condition to be achieved at the two substantially different outlets, and the electronic package 440 independently determines how to position the flap 420 to achieve the desired routing ratio. In some embodiment, the electronics package 440 includes an independent processor/microprocessor that is configured to determine how to position the flap 420 to achieve the desired routing ratio. Further, the electronics package, with or without using a processor/microprocessor, may be configured to output a signal indicative of the position of the flap 420 in the valve. In other embodiments, the processor/microprocessor of the valve 410 is configured to be in communication with other valves having respective processors/microprocessors, and may perform some or all of the functions of the control unit 700.

In some embodiments of the present invention, the valve 410 is configured to output a signal that is indicative of the identity of the specific valve (which may be related to the valves position within the HVAC system 100, more on this below), the current routing ratio of the valve and/or the relative position of the flap 420 within the diverter valve.

Power to drive the electronics package and stepper motor are conveyed to the valve 410 via wires in a network cable that may be connected to utility power and/or may be connected to a battery.

An exemplary scenario utilizing the HVAC system 100 of the first embodiment of the present invention will now be described, in which air temperature within room 910 is desired to be maintained at substantially the same temperature at two substantially different altitudes within the room 910. That is, in this exemplary scenario, the HVAC system is employed in a manner which provides a counter to the natural convection flow which otherwise concentrates the heated or cooled air at the floor or ceiling, respectively, of a room.

Sensor 620 determines that the air temperature at approximately one foot above the floor is 74 degrees Fahrenheit. Sensor 610 determines that the air temperature approximately seven feet above the floor is 77 degrees Fahrenheit. The sensor assembly outputs one or more signals indicative of the sensed temperatures and/or the temperature gradient at these two altitudes. This signal, or a relay of the information it contains, is received by control unit 700. Control unit 700 analyzes the signal(s) from sensor 610 and 620 and determines that the temperature in the portion of the room which may be most influenced by air exiting outlet 510 is higher than the air temperature of the portion of the room which may be most influenced by air exiting outlet 520. As the desired room temperature has been set for 73 degrees Fahrenheit by a user utilizing the user interface 800, control unit 700 outputs a control signal to diverter valve 410 to divert roughly 70 percent of the air traveling through duct 310 (which is cooled air) into duct 320 and thus out outlet 510. The remaining 30 percent of the air traveling through duct 310 travels through duct 330 and exits into room 910 through outlet 520 near the floor of room 910. The HVAC system 100 operates in this manner until the temperature at the two altitudes are substantially the same (e.g., 73 degrees plus or minus a half of a degree Fahrenheit, depending on the tolerancing/sensitivity of the system). In the scenario just described, the flap 420 is positioned so that a 70/30 routing ratio is achieved and maintained until the desired uniform temperature of 73 degrees is achieved. In other embodiments of the present invention, however, the flap may be readjusted during that period of time to achieve the substantially similar temperatures at the two different altitudes in a faster period of time or in a slower time period, and so that the changes in temperature do not occur in only a linear manner. In this regard, embodiments of the present invention may include feedback loops/logic systems which estimate how long it will take to achieve the desired uniform temperature at various routing ratios and thus may determine that the time that it will take to achieve that substantially uniform temperature will be too long for a room occupants comfort, etc. (based on, for example, look-up tables or algorithms stored in the system 100 developed from empirical data, etc.) and thus direct the valve 100 to route air at a different routing ratio during a given period of time. For example, an 80/20 routing ratio weighted toward the top outlet may be established for the first 75 seconds of operation, and then a 60/40 routing ratio weighted towards the top outlet may be established until the uniform temperature is achieved, after which, for example, a 55/45 routing ratio may be established to maintain the substantially uniform temperature. In another scenario, the system 100 may determine that the amount of cool air that is being directed out the top outlet 510, as compared to the amount of air being directed out the bottom outlet 520, is such that a user will feel uncomfortable and thus may change the routing ratio to obtain a more even flow (e.g. 60/40 ratio weighted towards the top outlet 510, etc.). In the event that the system determines that the user may feel that the system is overcompensating for the temperature imbalance, the system may direct the valve 410 to go to a 45/55 routing ratio weighted to the bottom outlet 520 for a brief period of time, and then switch back to a routing ratio weighted towards the top outlet 510.

Accordingly, embodiments of the present invention allow a substantially even temperature to be maintained between the floor and ceiling of the room 910 during a heating cycle and during a cooling cycle, under many, if not all, environmental conditions.

In another exemplary scenario, a desired temperature gradient at the two altitudes has been inputted by a user into the user interface 800, and thus the control unit 700 controls the routing ratio of the valve 410 to achieve this ratio. By way of example, if the desired temperature gradient in a room is an air temperature 1 foot off the floor of 72 degrees Fahrenheit and an air temperature 7 feet off the floor of 73 degrees Fahrenheit, and the lower sensor was sensing 72 degrees and the upper sensor was sensing 75 degrees, the control unit 700 may control the valve 410 to direct more of the air traveling through 310 into duct 320 and thus out outlet 510, as opposed to into duct 330 and thus outlet 520, in a manner sufficient to achieve the desired temperature gradient.

In an embodiment of the present invention, the HVAC system is configured to automatically execute a setup sequence in which the control unit 700 learns which position of the diverter valve 410 directs air to the higher outlet 510 and which position of the diverter valve 410 directs air to the lower outlet 520 (this sequence may be initiated by a user, or may be initiated automatically during the system's first use after installation, etc.). Accordingly, the HVAC system 100 of the present embodiment need not require instructions or other input from a user as to how the valves 410 are positioned within the system. In this regard, the system need not require stringent adherence to aligning the various outlets with specific ducts.

According to the first embodiment, the setup sequence includes a first period in which the control unit 700 directs the diverter valve 410 to place the flap 420 in a position such that the routing ratio is 100 to 0 (i.e. 100 percent of the air traveling through duct 310 travels to one of the outlets and 0 percent of the air travels to the other outlet). The sensors 610/620 output signals including information based on the sensed temperatures at the two substantially different altitudes within room 910. Based on the information regarding the temperatures at the sensed altitudes/a temperature difference between the two sensed altitudes/or a change in temperature over a period of time, etc., the control unit 700 may estimate which position of the valve is sending air thought which outlet. For Example, if the temperature at the lower sensor altitude changes much faster than the temperature at the higher sensed altitude, the control unit 700 may conclude that the current position of the flap 420 in valve 410 directs air to the lower outlet 520. (In some embodiments, this estimation may be delayed until after data is acquired during the second period, in which the flap 420 is reversed.) The setup sequence further includes a second period where the control unit commands the diverter valve 410 to direct air to only the other outlet (a routing ratio of 0/100 weighted towards the other outlet). The control unit then monitors output(s) from the sensor assembly regarding temperature changes, etc., and thus makes an estimation about which outlet to which the second position of the flap directs air. For example, once the flap is reversed, if the control unit 700 recognizes that the temperature changes more drastically at the higher sensed altitude than the lower sensed altitude, the control unit will conclude that the second position of the valve directs air to the higher outlet. In this scenario, this second period is used to ratify the estimation of the control unit 700 that it made in the first period. However, in other scenarios, if there is no estimation made after the first period, and the control unit waits until the second period to evaluate the data recorded during both periods, the control unit 700 may compare the data from both periods to make its estimation. With the setup sequence complete, the invention may now use the diverter valves 410, along with real time data collected from the two sensors 610 and 620 to optimally distribute air between the upper and lower vents 510 and 520.

The setup sequence may be executed during a heating cycle and/or during a cooling cycle. In some embodiments of the present invention, the setup sequence may be executed outside of a heating cycle and/or a cooling cycle.

Embodiments of the present invention may include control units 700 that include logic to evaluate the temperature sensed at the two sensed altitudes and utilize the logic to vary the routing ratios of the valve 410 to maintain the desired uniform temperature/temperature gradient in real time.

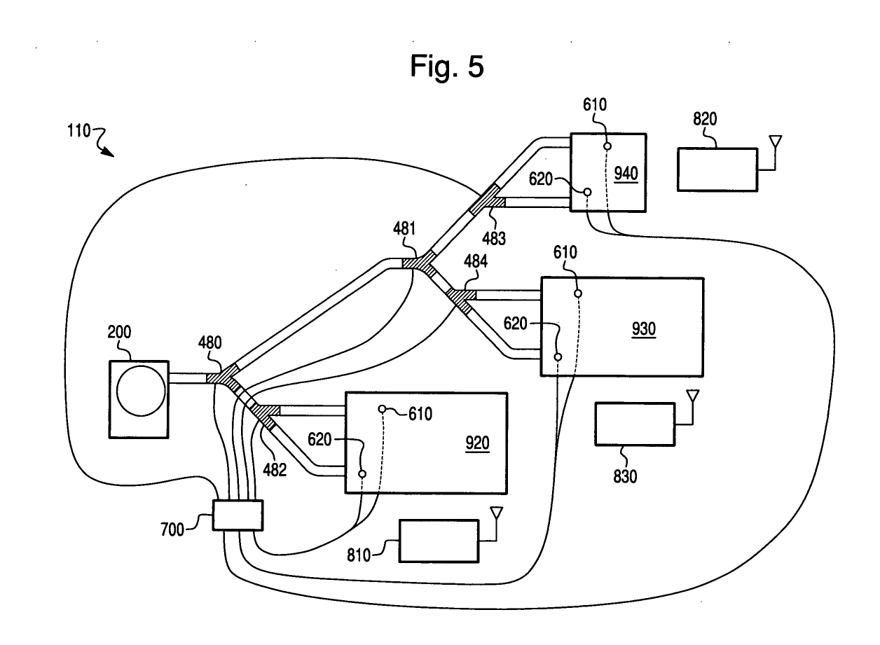

In another embodiment of the present invention, referring now to FIG. 5, multiple diverter valves are utilized in a forced air HVAC system 110. In this embodiment, the diverter valves are substantially similar and/or the same as the diverter valve 410 presented above. The diverter valves have a similar functionality as the diverter valve presented in reference to FIGS. 1-4, and, in the microanalysis of the system, the individual diversion valves function in a similar manner/in a same manner as the valve 410. That is, the diverter valves function to divert air entering the valves down two different paths without causing deleterious changes in backpressure. However, in the macroanalysis of the system, in this embodiment, the two different paths into which the air is diverted may lead to additional diverter valves. For example, diverter valve 480 diverts air exiting from heater/cooler unit 200 down two different channels, each of the channels leading to a respective additional diverter valves 481 and 482. In some embodiments of the present invention, the additional second diverter valves (i.e. the diverter valve downrange from the first diverter valve) in the associated ducting may be arranged in a manner substantially the same as that depicted in FIG. 1. That is, the downrange diverter valves diverts air into two ducts that lead to two separate outlets within a room, the outlets being at substantially different heights from one another (see, e.g., diverter valve 482). In this regard, room 920 in FIG. 5 is analogous to room 910 depicted in FIG. 1, and while not shown in FIG. 5, the outlets leading from the other diverter valve (e.g., diverter valve 481) may lead to a room substantially the same as that depicted in FIG. 1. However, in other embodiments, such as that depicted in FIG. 5, the diverter valve 481 diverts air down to ducts which lead to additional diverter valves, such as the two other diverter valves 483 and 484, which respectively divert air to rooms 930 and 940. The ducting arrangement and outlet arrangement of rooms 930 and 940 is analogous to the arrangement depicted for room 910 in FIG. 1. Still further, the sensor assembly arrangements in these rooms are also analogous to those depicted in FIG. 1. Thus, according to this embodiment, multiple diverter valves may be utilized to maintain uniform/nonuniform temperature gradients (with respect to altitude)/and/or other uniform environmental conditions (with respect to altitude) in multiple rooms receiving conditioned air from a single unit 200.

In the embodiment of FIG. 5 utilizing multiple diverter valves, multiple user interfaces 810, 820 and 830 may be utilized, although in some embodiments of the present invention, only a single user interface may be utilized. The user interfaces 810, 820, 830 are used to control the environmental conditions in rooms 920, 930 and 940, respectively. In the embodiment depicted in FIG. 5, the user interfaces are in wireless communication with the control unit 700 utilizing RF communication or the like, although the user interfaces may be hardwired to the control unit 700 (or an intermediary device).

As may be seen, each of the rooms 920, 930 and 940, have two sensors each and thus have a single dedicated sensor assembly for each room. Control unit 700 is in communication with the various diverter valves and sensor assemblies within the system 110, and thus controls the routing ratios of the various valves to maintain and/or achieve the desired/optimum temperature and/or other environmental conditions desired in each room, through real time environmental condition sensing in the rooms and real time control of the various diverter valves. Embodiments of the present invention are versatile enough to allow a virtually unlimited number of valves to intelligently coordinate the respective positions of their internal flaps to direct air through alternate paths. These paths may be selected in real time based on input from sensors connected to the communication network.

Accordingly, embodiments invention may have adjustable sensitivities to how the control unit 700 reacts to a difference in temperature. By networking the diverter valves into a control system, the action of all the valves may be coordinated to optimize, balance and/or prioritize, in real-time, the distribution of air throughout the entire system.

As with the embodiment previously described above, embodiments of the forced air HVAC system utilizing multiple diverter valves may include a setup sequence, which is, in some embodiments is analogous to that described above. In this regard, the control unit 700 may first identify how many diverter valves are present in the system 110. The control unit 700 then proceeds to determine how the positions of the flaps within the various diverter valves influence airflow downstream of those diverter valves. Because there are multiple diverter valves, the control unit 700 may assign the various diverter valves individual names/identifiers so that it can identify which diverter valves the control unit is in communication with. Alternatively, in other embodiments the diverter valves may imbed identification signals in signals that are outputted to the control unit. With regard to control unit 700 assigning valves names/identifiers, in some embodiments, the control unit is in actuality assigning names/identifiers to the communication paths to the outlets. That is, the control unit 700, in some embodiments, need only know which communication paths will communicate with different diverter valves.

The setup sequence proceeds in a manner analogous to that described above. In a first period, the control unit 700 places the flaps of all the diverter valves to positions such that one outlet is fully closed and the other outlet is fully opened. The heating/cooling unit 200 is then activated and temperature changes within the various rooms are monitored. Then, the control unit 700 command one of the valves (or more than one, if the setup process can tolerate such multitasking) to move its flap so that the outlet that was previously receiving air from its respective inlet now receives no air, and the other outlet which was previously restricted from receiving air from its respective inlet now receives all of the air from its respective inlet. During this period, the temperature changes are again sensed in the various rooms, and the software/firmware/logic circuits of control unit 700 analyze the data received from the sensors (which may be recorded) and attempt to estimate which valve is being controlled and what the control does. In the embodiment depicted in FIG. 5, for example, if a higher altitude sensor 610 depicts a relatively extreme temperature change as compared to the lower sensor 620 in a given room such as, for example, room 930 the control unit 700 may conclude that the diverter valve with which it has just commanded to change its position is valve 484, and also that its current flap position is such that the air being directed out of valve 484 is directed towards the outlet that is closer to the ceiling of the room 930. The control unit 700 may then direct another valve to change its position, after which the sensed environmental condition (i.e., temperature in this exemplary scenario) of the rooms will then again be monitored for a change. Eventually, the control unit 700 will command valve 480 to change its position, at some point during the sequence. Accordingly, either room 920 or rooms 930 and 940 will no longer receive conditioned air, whereas previously the opposite was the case. By sensing changes in environmental conditions (temperature) in the various rooms, it can be determined that the valve 480 influences the amount of a flowing into all of the rooms 920 930 and 940.

Alternatively, if control unit 700 commands valve 481 to change its position, the temperature changes in rooms 930 and 940 may be analyzed/recorded and a determination may be made by the control unit 700 that valve 481 controls airflow into these rooms. As may be seen, the more valves that are positioned within the system 110, the greater the number of iterations that the control unit 700 must direct the system to go through to determine which valves influence which rooms and how those valves influence those rooms. Through proper programming utilizing proper software and/or firmware, etc., the setup sequence may be implemented to obtain the necessary positioning an identification information, regardless of how many diverter valves are within the system.

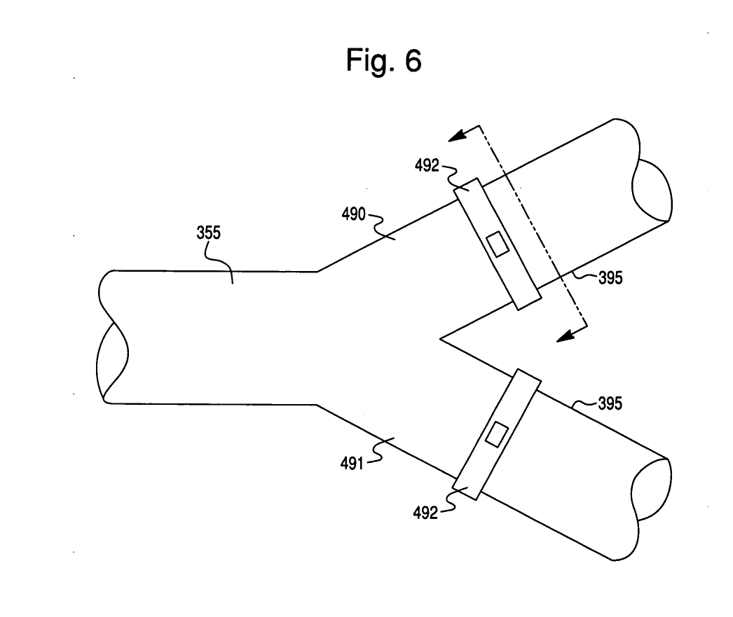

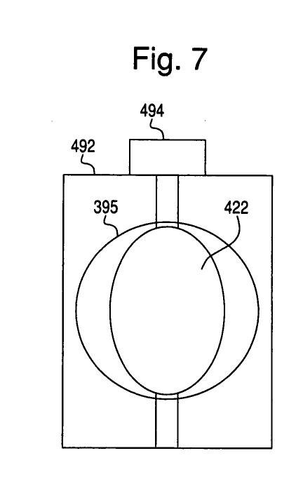

The diverter valves described heretofore utilize a stepless flap in order to divert air down the various passages at the various routing ratios. However, other types of valves may be utilized, providing that the valves do not restrict the overall airflow through the system and thus cause a deleterious change in backpressure. In this regard, synchronized butterfly valves may be utilized as depicted in FIGS. 6 and 7. In FIG. 6, a duct 355 branches into two branches 490 and 491. The branches 490 and 491 lead to butterfly valves 492, which in an exemplary embodiment of the present invention, are butterfly valves according to that presented in FIG. 7, where the flap 422 is shown being positioned at roughly a 45 degree angle opening with respect to the axial direction of the duct housing 395. Butterfly valves 492 include an electric motor 494 and an electronics package which places the valve into communication with the control unit 700 and/or with each other. The motor 492 moves the flap 422 within the housing 395 of the ducts leading away from the main duct 355. In the embodiment using such valves, the control unit is configured so that the position of the valves are choreographed/synchronized such that the valves are opened and closed in a manner that does not substantially restrict the general airflow flowing through duct 355, and thus does not create an increase in backpressure. In this regard, for example, if one of the butterfly valves 492 has its flap 422 positioned such that it will permit roughly 10 percent of the air traveling down duct 355 to pass through the valve, the other butterfly valve will have its flap 422 positioned such that it permits 90 percent or so of the air traveling down 355 to pass around through. Thus, by correlating the movements of the flaps 422 of the two butterfly valves, a diverter valve can be obtained from the plurality of valves. That is, air may be diverted in a manner analogous to the diverter valve depicted in FIG. 2, providing that the butterfly valves are linked to each other. In some embodiments, the control unit 700 controls the position of each individual butterfly valve, while in other embodiments, the butterfly valves are linked together in a butterfly valve assembly such that the control unit 700 need only output a command to achieve a given routing ratio, and the butterfly valves position themselves autonomously to obtain the desired routing ratio.

While some embodiments of the present invention control the environmental condition of temperature at the various altitudes within the rooms, other embodiments may be implemented for the distribution of fresh air (non-temperature conditioned) into specific areas as desired. Such requirements could occur as the result of elevated CO₂ or depleted oxygen levels in a room which contained a concentrated gathering of people, or a purging of CO if a defective exhaust system causes a hazardous concentration of the gas in a particular area, etc., in such cases, sensor assemblies that may monitor such environmental conditions will be utilized. Accordingly, environmental conditions may include temperature, humidity, CO₂, CO and VOC levels.

The present invention includes methods to practicing the invention, software to practice the invention, logic (that is hardware and or software and or firmware, etc.), and apparatuses configured to implement the present invention. Accordingly, the present invention includes a program product and hardware and firmware for implementing algorithms to practice the present invention, as well as the systems and methods described herein, and also for the control of the devices and implementation of the methods described herein.

It is noted that the term “processor,” as used herein, encompasses both simple circuits and complex circuits, as well as computer processors. The term also encompasses microprocessors.

This application incorporates by reference in its entirety the contents of the U.S. Patent Application entitled HVAC Air Distribution System (U.S. patent application Ser. No. 11/812,239), filed on Jun. 15, 2007, to inventors Gerald Allen, Machiko Taylor and Justin Dobbs, all of California USA.

Given the disclosure of the present invention, one versed in the art would appreciate that there may be other embodiments and modifications within the scope and spirit of the present invention. Accordingly, all modifications attainable by one versed in the art from the present disclosure within the scope and spirit of the present invention are to be included as further embodiments of the present invention. The scope of the present invention accordingly is to be defined as set forth in the appended claims.

What is claimed is:

1. A flow diverter valve, comprising:
a diverter valve body including:
an inlet;
a first outlet; and
a second outlet;
a flow constrictor assembly; and
at least one motor adapted to adjust the flow constrictor assembly to divert air entering the inlet to the first and second outlet and maintain a substantially constant backpressure in front of the valve during air diversion.

2. The diverter valve of claim 1, wherein the at least one motor is adapted adjust the flow constrictor assembly to route air entering the inlet into the outlets at varying routing ratios.

3. The diverter valve of claim 2, wherein the diverter valve is adapted to receive a communication signal indicative of a command to change a routing ratio of air routed into the two outlets and substantially steplessly vary the routing ratio of air routed into the two outlets based on that communication.

4. The diverter valve of claim 3, wherein the motor is a stepper motor, wherein the flow constrictor assembly includes a flap, and wherein the stepper motor is adapted to move the flap to accordingly vary the routing ratio of air routed into the two outlets.

5. The diverter valve of claim 3, wherein the motor is an electrical stepper motor, wherein the flow constrictor assembly includes a flap hinged at a location between the two outlets with a hinge, wherein the electrical stepper motor is mechanically linked to the flap such that the electrical stepper motor is adapted to impart a tension force to the flap to move the flap in a counter clockwise rotation with respect to the hinge and a compression force to the flap to move the flap in a clockwise rotation with respect to the hinge so as to move the flap to accordingly vary the routing ratio of air routed into the two outlets via the impartation of the tension force and the compression force.

6. The diverter valve of claim 3, wherein the flow constrictor assembly includes a flap hinged at a location between the two outlets, wherein the motor is mechanically linked to the flap such that the motor is adapted to move the flap in a clockwise rotation and a counterclockwise rotation, with respect to a rotational centerline, through an arc crossing about the diameter of the inlet so as to accordingly vary the routing ratio of air routed into the two outlets via movement of the flap through the arc.

7. The diverter valve of claim 6, wherein the motor is a stepper motor and is adapted to position the flap at various degrees of inclination with respect to one end of the arc of rotation, so as to vary the routing ratio of air routed into the two outlets.

8. The diverter valve of claim 1, wherein the motor is adapted adjust an area of a communication path between the inlet and the first outlet and is adapted to adjust an area of a communication path between the inlet and the second outlet in varying amounts so as to vary the routing ratio of the air routed into the two outlets.

9. The diverter valve of claim 3, wherein the diverter valve is adapted to output a signal indicative of at least one of the identity of the diverter valve, a current routing ratio of the diverter valve, and a position of a component of the flow constrictor assembly that influences the routing ratio of the diverter valve.

10. The diverter valve of claim 1, wherein the diverter valve includes an electronics package configured to control the motor to adjust the flow constrictor assembly to divert air entering the inlet to the first and second outlets based on one or more signals received by the electronics package.

11. The diverter valve of claim 10, wherein the electronics package is adapted to receive one or more signals indicative of an identified first environmental condition at two substantially different sensed spatial locations remote from the diverter valve and control the motor to adjust the flow constrictor assembly to divert air entering the inlet to the first and second outlets based on the identified first environmental conditions at the two substantially different sensed spatial locations remote from the diverter valve.

12. The diverter valve of claim 10, wherein the electronics package is adapted to receive one or more signals indicative of an identified first environmental condition at two substantially different sensed spatial locations remote from the diverter valve and control the motor to adjust the flow constrictor assembly to varyingly divert air entering the inlet to the first and second outlets based on the identified first environmental conditions at the two substantially different sensed spatial locations remote from the diverter valve so that at least one of (i) the first environmental condition is substantially the same at the two substantially different sensed spatial locations remote from the diverter valve, and (ii) a desired gradient of the first environmental condition is substantially maintained at the two substantially different sensed spatial locations remote from the diverter valve.

13. The diverter valve of claim 12, wherein the electronics package includes a processor that is adapted to automatically execute a setup sequence in which the electronics package learns which position of the diverter valve directs air to a higher of a first and second room outlet remote from the diverter valve and which position of a component of the diverter valve directs more air to a lower of the first and second room outlets, the setup sequence including:
(i) a first period in which:
the processor controls the diverter valve to direct air to only one of the first and second outlets, and
data is received by the processor indicative of at least one of a first temperature difference between the two substantially different sensed spatial locations remote from the diverter valve and a first temperature change over a period of time at the two substantially different sensed spatial locations remote from the diverter valve based on information obtained by a sensor assembly remote from the diverter valve,
(ii) a second period in which:
the processor commands the diverter valve to direct air to only another, with respect to the first period, of the first and second outlets, and
data is received by the electronics package indicative of at least one of a second temperature difference between the two substantially different sensed spatial locations remote from the diverter valve and a second temperature change over a period of time at the two substantially different sensed spatial locations remote from the diverter valve based on information obtained by the sensor assembly, and
(iii) a third period in which the processor compares the received data and identifies which position of the diverter valve directs air to the higher and lower room outlets based on the comparison.

14. The diverter valve of claim 11, wherein the first environmental condition is temperature, and wherein the electronics package is adapted to varyingly route air entering the diverter valve to the first and second outlets to maintain predetermined temperatures at the two substantially different spatial locations remote from the diverter valve, the electronics package including logic which is utilized to varyingly route the air based on real time identification of variables relating to the temperatures identified by a first sensor assembly at the two substantially different spatial locations remote from the diverter valve.

15. The diverter valve of claim 11, wherein the electronics package is adapted to automatically execute a setup sequence in which:
the electronics package autonomously learns which position of the diverter valve directs air to a higher of first and second room outlets and which position of the diverter valve directs air to a lower of the first and second room outlets.

16. The diverter valve of claim 1, wherein the diverter valve is adapted to change a routing ratio in about 10% increments.

17. The diverter valve of claim 1, wherein the diverter valve is adapted to change a routing ratio in about 5% increments.

18. The diverter valve of claim 1, wherein the diverter valve includes a processor adapted to control a position of a flap within the diverter valve to divert an air stream flowing out of the diverter valve so that a specified air temperature at two substantially different spatial locations remote from the diverter valve may be obtained and/or maintained.

19. The diverter valve of claim 1, wherein the diverter valve is an intelligent diverter valve that is adapted to receive a signal indicative of a desired routing ratio of the diverter valve and control a position of a flap within the diverter valve so that the desired routing ratio is achieved.

20. The diverter valve of claim 11, wherein the diverter valve is adapted to autonomously determine how to adjust the flow constrictor assembly to divert air entering the inlet to the first and second outlets based on the identified first environmental conditions.

21. The diverter valve of claim 18, wherein the processor is adapted to autonomously determine where to position the flap to divert the airstream flowing out of the diverter valve so that the specified air temperature at the two substantially different spatial locations may be obtained.

22. The diverter valve of claim 1, wherein the diverter valve includes an electronics package adapted to communicate with a second flow diverter valve that includes:
a second diverter valve body including:
a second inlet;
a third outlet; and
a fourth outlet;
a second flow constrictor assembly; and
at least one motor adapted to adjust the second flow constrictor assembly to divert air entering the second inlet to the third and fourth outlet and maintain a substantially constant backpressure in front of the second diverter valve during air diversion.
